(19) United States
(12) Patent Application Publication
(10) Pub. No.: US 2025/0057144 A1
(43) Pub. Date: Feb. 20, 2025

(54) DETERMINING NOZZLE FOR PESTICIDE AND/OR BIOSTIMULANT APPLICATION

(71) Applicant: Syngenta Crop Protection AG, Basel (CH)

(72) Inventors: James Frederick DE LA HAY MARSHALL ROBERTS, Cambridge (GB); Jeanne-Lise PHUNG, Basel (CH); James William THOMAS, Cambridgeshire (GB); Henning MEINECKE, Frankfurt am Main (DE); Marco Uwe REITZ, Frankfurt am Main (DE)

(73) Assignee: Syngenta Crop Protection AG, Basel (CH)

(21) Appl. No.: 18/720,026

(22) PCT Filed: Dec. 1, 2022
(86) PCT No.: PCT/EP2022/084032

§ 371 Date: Jun. 14, 2024

(30) Foreign Application Priority Data
Dec. 17, 2021 (EP) 21215691.3

(51) Int. Cl. A01M 7/00

(52) U.S. Cl. CPC A01M 7/0092; A01M 7/0042

(57) ABSTRACT

A computing device for determining a nozzle for pesticide and/or biostimulant application is provided. The computing device is configured to receive an input on windspeed and/or relative humidity of an area where a pesticide and/or biostimulant is to be applied, determine a nozzle for applying a pesticide and/or biostimulant for improving plant health based on said input, and send information on the nozzle to a user device.

### TECHNICAL FIELD

The present disclosure relates to computing devices such as a server configured to determine a nozzle for pesticide and/or biostimulant application. The present disclosure also relates to apparatus, computer program and computer program product configured to determine a nozzle for pesticide and/or biostimulant application, as well as a method for determining a nozzle for pesticide and/or biostimulant application.

### BACKGROUND

In the agricultural industry pesticides are typically applied to plants to protect them against plant pathogens such as weeds, fungi, viruses and bacteria. Biostimulants may be applied to plants, seeds or the root environment to stimulate natural processes to benefit uptake or more effective use of nutrients, increase stress tolerance or enhance crop quality, independently of their nutrient content.

Both pesticides and biostimulants may be suspended in water and applied to plants by spraying. During application, the pesticide or biostimulant is broken into droplets of various sizes. Smaller droplets are more prone to drift whereas larger droplets are heavier and so fall more quickly to the ground and as such are less affected by air movement. Generally, farmers try to reduce drift so that the application of the pesticide or biostimulant is targeting the intended plant and does not reach other off-target areas such as unintended plants, water supplies and wildlife.

As droplets in a spray volume range in size, the droplet size of a spray volume is often referred to in terms of “droplet size category” which gives a range of the volume median diameter (VMD) of droplets present in a spray volume. The droplet size category affects the biological efficiency of pesticides and biostimulants and so in order to optimise the result droplet size category needs to be carefully considered before application. The droplet size category is determined by the nozzle and pressure used for applying the pesticide or biostimulant, whereof the pressure is dependent on the driving speed of the vehicle used for applying the treatment. For example, a higher driving speed results in higher pressure applied. Furthermore, the combination of the pressure and the driving speed of the vehicle determines how much water that is needed per hectare, this is often referred to as “water volume”. As such, when a farmer is to apply pesticide or biostimulant to a field of crops or plants, there are several interlinked parameters they must consider in order for the treatment to have an optimal effect.

### SUMMARY OF THE DISCLOSURE

According to an aspect of the present disclosure, there is provided a computing device for determining a nozzle for pesticide and/or biostimulant application. The computing device is configured to receive an input on windspeed and/or relative humidity of an area where a pesticide and/or biostimulant is to be applied; receive application information comprising crop type to be treated by the pesticide and/or biostimulant, type of pesticide and/or biostimulant to be applied, and crop growth stage. The computing device is further configured to determine a minimum required drift reduction and/or a suitable droplet size category whilst achieving a desired biological efficiency of the pesticide and/or biostimulant, wherein the minimum required drift reduction and/or droplet size category is based on windspeed and/or relative humidity and the application information; receive information on at least one available nozzle for pesticide and/or biostimulant application. The computing device is further configured to determine at least one suitable nozzle based on the at least one available nozzle, wherein the at least one suitable nozzle is suitable for applying pesticide at or above the determined minimum required drift reduction and/or at the suitable droplet size category; determine at least one workable pressure for each suitable nozzle to deliver pesticide and/or biostimulant at or above the determined minimum required drift reduction and/or at the suitable droplet size category, wherein the at least one workable pressure for each suitable nozzle is determined based on its technical specification; determine at least one workable flow rate of pesticide and/or biostimulant application for each suitable nozzle based on its technical specification; determine a desired workable flow rate of pesticide and/or biostimulant application based on a speed of a vehicle configured to apply the pesticide and/or biostimulant, a water volume and spacing between nozzles; determine the optimal flow rate for each suitable nozzle based on the workable flow rate that is closest to the desired workable flow rate and within a maximum and minimum flow rate dictated by the driving speed of the vehicle configured to apply the pesticide and/or biostimulant; determine a recommended nozzle based on the optimal flow rate of the at least one suitable nozzle for applying a pesticide and/or biostimulant for improving plant health based on said input, and send information on the nozzle to a user device.

The computing device may be further configured to determine a nozzle for applying a pesticide and/or biostimulant for improving plant health comprises the computing device being configured to determine a nozzle for applying a pesticide and/or biostimulant for optimising biological efficiency of the pesticide and/or biostimulant whilst minimising drift of the pesticide and/or biostimulant.

The computing device may be further configured to determine a driving speed of a vehicle configured to apply pesticide and/or biostimulant, pressure of pesticide and/or biostimulant application, and/or water volume.

The computing device may be further configured to determine the recommended nozzle based on a rating of the at least one suitable nozzle, wherein the rating is based on the at least one suitable nozzle's suitability for a specific crop, suitability for a type of pesticide and/or biostimulant, and/or the type or growth stage of the specific crop.

The computing device may be further configured to determine a recommended pressure for applying the pesticide and/or biostimulant based on the optimal flow rate.

The computing device may be further configured to determine a recommended driving speed of the vehicle configured to apply the pesticide and/or biostimulant based on water volume and the recommended pressure for each suitable nozzle.

The computing device may be further configured to determine if the pesticide and/or biostimulant should even be applied based on windspeed.

The computing device may be configured to receive a tuning input for readjusting one of the recommendations of a nozzle, driving speed of the vehicle and pressure, and based on said tuning input the computing device is further configured to adjust the remaining recommendations not included in the tuning input.

According to a further aspect of the disclosure, a method performed by a computing device for determining a nozzle for pesticide and/or biostimulant application is provided. The method comprising receiving an input on windspeed and/or relative humidity of an area where a pesticide and/or biostimulant is to be applied; receiving application information comprising crop type to be treated by the pesticide and/or biostimulant, type of pesticide and/or biostimulant to be applied, and crop growth stage. The method further comprising determining a minimum required drift reduction and/or a suitable droplet size category whilst achieving a desired biological efficiency of the pesticide and/or biostimulant, wherein the minimum required drift reduction and/or droplet size category is based on windspeed and/or relative humidity and the application information; receiving information on at least one available nozzle for pesticide and/or biostimulant application. The method further comprising determining at least one suitable nozzle based on the at least one available nozzle, wherein the at least one suitable nozzle is suitable for applying pesticide at or above the determined minimum required drift reduction and/or at the suitable droplet size category; determining at least one workable pressure for each suitable nozzle to deliver pesticide and/or biostimulant at or above the determined minimum required drift reduction and/or at the suitable droplet size category, wherein the at least one workable pressure for each suitable nozzle is determined based on its technical specification; determining at least one workable flow rate of pesticide and/or biostimulant application for each suitable nozzle based on its technical specification; determining a desired workable flow rate of pesticide and/or biostimulant application based on a speed of a vehicle configured to apply the pesticide and/or biostimulant, a water volume and spacing between nozzles; determining the optimal flow rate for each suitable nozzle based on the workable flow rate that is closest to the desired workable flow rate and within a maximum and minimum flow rate dictated by the driving speed of the vehicle configured to apply the pesticide and/or biostimulant; determining a recommended nozzle based on the optimal flow rate of the at least one suitable nozzle for applying a pesticide and/or biostimulant for improving plant health based on said input, and sending information on the nozzle to a user device.

According to another aspect of the present disclosure, there is provided a computing device for determining a nozzle for pesticide and/or biostimulant application. The computing device is configured to receive an input on windspeed and/or relative humidity of an area where a pesticide and/or biostimulant is to be applied, determine a nozzle for applying a pesticide and/or biostimulant for improving plant health based on said input, and send information on the nozzle to a user device.

The computing device may be further configured to determine a nozzle for applying a pesticide and/or biostimulant for improving plant health comprises the computing device being configured to determine a nozzle for applying a pesticide and/or biostimulant for optimising biological efficiency of the pesticide and/or biostimulant whilst minimising drift of the pesticide and/or biostimulant.

The computing device may be further configured to determine a driving speed of a vehicle configured to apply pesticide and/or biostimulant, pressure of pesticide and/or biostimulant application, and/or water volume.

The input may further comprise an application information comprising: crop type to be treated by the pesticide and/or biostimulant, type of pesticide and/or biostimulant to be applied, and crop growth stage, and the computing device may be further configured to determine a minimum required drift reduction and/or a suitable droplet size category whilst achieving a desired biological efficiency of the pesticide and/or biostimulant, wherein the minimum required drift reduction and/or droplet size category is based on windspeed and/or relative humidity and the application information.

The input may further comprise at least one available nozzle for pesticide and/or biostimulant application, and the computing device may be configured to determine at least one suitable nozzle based on the at least one available nozzle, wherein the at least one suitable nozzle is suitable for applying pesticide at or above the determined minimum required drift reduction and/or at the suitable droplet size category.

The computing device may be further configured to determine at least one workable pressure for each suitable nozzle to deliver pesticide and/or biostimulant at or above the determined minimum required drift reduction and/or at the suitable droplet size category, wherein the at least one workable pressure for each suitable nozzle is determined based on its technical specification.

The computing device may be further configured to determine at least one workable flow rate of pesticide and/or biostimulant application for each suitable nozzle based on its technical specification.

The computing device may be further configured to determine a desired workable flow rate of pesticide and/or biostimulant application based on a speed of a vehicle configured to apply the pesticide and/or biostimulant, a water volume and spacing between nozzles.

The computing device may be further configured to determine the optimal flow rate for each suitable nozzle based on the workable flow rate that is closest to the desired workable flow rate and within a maximum and minimum flow rate dictated by the driving speed of the vehicle configured to apply the pesticide and/or biostimulant.

The computing device may be configured to determine a recommended nozzle based on the optimal flow rate of the at least one suitable nozzle.

The computing device may be further configured to determine the recommended nozzle based on a rating of the at least one suitable nozzle, wherein the rating is based on the at least one suitable nozzle's suitability for a specific crop, suitability for a type of pesticide and/or biostimulant, and/or the type or growth stage of the specific crop.

The computing device may be configured to determine a recommended pressure for applying the pesticide and/or biostimulant based on the optimal flow rate.

The computing device may be configured to determine a recommended driving speed of the vehicle configured to apply the pesticide and/or biostimulant based on water volume and the recommended pressure for each suitable nozzle.

The computing device may be further configured to determine if the pesticide and/or biostimulant should be applied at all based on windspeed.

The computing device may be configured to receive a tuning input for readjusting one of the recommendations of a nozzle, driving speed of the vehicle and pressure, and based on said tuning input the computing device is further configured to adjust the remaining recommendations not included in the tuning input.

The computing device disclosed herein may be a server or several servers configured to communicate with the user device and/or other servers via a fixed or wireless interface.

According to another aspect of the disclosure a computer program is provided. The computer program, when run on a computer, causes the computer to perform any of the methods described herein.

According to a further aspect of the disclosure, a computer program product is provided. The computer program product comprising computer readable storage medium and the computer program described herein stored on the computer readable storage medium.

According to another aspect of the disclosure, there is provided an apparatus for determining a nozzle for pesticide and/or biostimulant application. The apparatus comprising a processing circuitry and a memory. The memory contains instructions executable by said processing circuitry whereby said apparatus is operable to perform any of the methods described herein.

According to yet another aspect of the disclosure, a method performed by a computing device for determining a nozzle for pesticide and/or biostimulant application is provided. The method comprising receiving an input on windspeed and/or relative humidity of an area where a pesticide and/or biostimulant is to be applied, determining a nozzle for applying a pesticide and/or biostimulant for improving plant health based on said input, and sending information on the nozzle to a user device.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow diagram of an example method of the present disclosure;

FIG. 2 is a flow diagram of an example method of the present disclosure;

FIG. 2b is a flow diagram of an example method of the present disclosure;

FIG. 2c is a flow diagram of an example method of the present disclosure;

FIG. 3 is a block diagram illustrating an apparatus operative to carry out methods of the present disclosure;

FIGS. 4a, 4b and 4c is a flow diagram of an example method of the present disclosure;

FIGS. 5a and 5b is a flow diagram of an example method of the present disclosure; and

FIG. 6 is a block diagram illustrating an apparatus of the present disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

As discussed in the background section, the application of pesticides and biostimulants needs to be carefully considered in order to optimise their biological efficiency and at the same time to reduce drift. There are several parameters that effect biological efficiency and/or drift including droplet size category, pressure used when applying the pesticide or biostimulants, driving speed of vehicle configured to apply the pesticide or biostimulants, water volume, the type of nozzle used for application, crop type and growth stage of the crop, as well as environmental factors such as relative humidity and windspeed. All of these factors are interlinked and so when a farmer is to apply pesticides or biostimulants to their plants or crops, the complexity of determining the type of nozzle, pressure, water volume and driving speed of the vehicle may result in less optimal biological efficiency of the pesticide or biostimulants and/or drift above a desired level.

The present disclosure provides servers, methods, apparatus, computer programs and computer program products aimed to achieve delivery of pesticide or biostimulants at a desired or optimal biological efficiency of the pesticide or biostimulants whilst also minimising or maintaining the drift below a specific level. In one aspect, this is achieved by determining a nozzle for applying the pesticide and/or biostimulant, pressure, driving speed of a vehicle configured to apply the pesticide and/or biostimulant, and/or water volume to be used when applying the pesticide and/or biostimulant.

Terminologies used herein will now be described.

Biological efficiency used herein refers to the efficiency of a pesticide and/or biostimulant in relation to the health of a plant exposed to said pesticide and/or biostimulant, or the health of a plant growing in an area that is treated with said pesticide and/or biostimulant. For example, the biological efficiency of a pesticide may be improved with smaller droplet size category as the application of pesticide will cover a greater surface area of the plant than greater droplet size category.

Biostimulant is to be understood as a chemical or biological agent(s) configured to stimulate a natural process in order to benefit uptake or more effective use of nutrients, increase stress tolerance or enhance crop quality, independently of their nutrient content.

Computing device used herein may be a server, several servers, apparatus comprising a memory and a processor configured to perform computing tasks, or a user device.

Crop type or plant type used herein is to be understood as a type of crop or plant. Examples of a crop or plant includes barley, wheat, maize, apples, beans, potatoes and rye.

Crop growth stage or growth stage of a crop used herein is to be understood as the phase of development that the plant or crop is at, for example, for cereals the crop growth stages are germination and emergence, leaf development, tillering, stem elongation, ear/inflorescence emergence, flowering/anthesis, milk/seed/grain/fruit development, dough development, and ripening/senescence.

Drift is the airborne movement of pesticide and/or biostimulant from an area of application to any unintended site.

As used herein, droplet size category is based on the size of the droplets. Droplet size is the diameter of a droplet and it is typically measured in microns. In a spray volume the droplet size varies as there will be a range of different sized droplets. The volume median diameter (VMD) is often referred to as denoting the droplet size in a spray volume and it is where half of the volume spray is in droplets smaller than the median and half of the volume is in droplets larger than the median. Droplet size category may therefore be defined as a range of VMD with an upper and a lower VMD, for example, “fine” droplet size category may refer to VMD of 0-249 microns, “medium” droplet size category may refer to VMD of 250-349 microns and “coarse” droplet size category may refer to VMD of 350-449 microns.

A nozzle is used for applying pesticide and/or biostimulant to a plant or plant locus. The nozzle attaches to an application system of a vehicle, and in use it disperses the pesticide and/or biostimulant into droplets targeting the intended plant(s). Nozzles can be configured in various ways to control the direction of application as well as the droplet size category. A farmer may have different types of nozzles that can spray pesticide/biostimulant at different droplet size categories and different levels of drift. As such, the choice of nozzle depends on which pesticide/biostimulant to be used, growth stage of the plant and type of plant, whilst trying to achieve optimal biological efficiency of the pesticide and/or biostimulant whilst minimising drift. The features of a nozzle affecting the droplet size and different levels of drifts are the size of the apertures or outlets and also the design of the nozzle, for example it can be flat-fan, flood, raindrop, hollow-cone, or full-cone.

Nozzle flow used herein is the flow rate of pesticide and/or biostimulant through or from a nozzle and it may be expressed as volume per time unit, for example, litre per minute.

Nozzle spacing used herein is the distance between nozzles on an application system.

Pesticide is to be understood as a chemical or biological agent(s) used for protecting a plant against a pathogen or from weeds. Examples of pesticides include herbicide, fungicide and insecticide.

Plant health used herein should be understood as the health of a plant which may, for example, deteriorate as it is attacked by a plant pathogen such as bacteria, virus or fungi, or it may improve by the application of a pesticide. Plant health may also improve with the application of a biostimulant.

The term pressure as used herein, unless explicitly referred to as otherwise, is in relation to the pressure when applying the pesticide and/or biostimulant rather than the intrinsic pressure of the pesticide and/or biostimulant. The pressure can be regulated by the driving speed of the vehicle configured to apply the pesticide and/or biostimulant. For example, the greater the driving speed the greater the pressure.

Relative humidity referred to herein is the amount of water vapour present in the air expressed as a percentage (or other appropriate index) of the amount needed for saturation at the same temperature. The relative humidity affects drift in that the higher the relative humidity the lower the drift, and so the drift needs to be minimized or managed by selecting a nozzle with appropriate droplet size category and appropriate pressure, whilst considering optimal biological efficiency.

User device is to be understood as a smart phone, user equipment, tablet or any other suitable computing device. Although not illustrated in the present disclosure, a user device should be understood to comprise communication means for receiving and sending messages, data, input and/or information with other devices such as a server. The communication means may be wireless or wired communication means, where wireless communication means may use a mobile phone network such as 3G, 4G or 5G.

Water volume is the number of litres per hectare to be used when applying the pesticide and/or biostimulant. It should be understood that the water volume can be defined in alternative units and is not limited to litres per hectare. Water volume may be calculated or express as;

$$Water volume in l / ha = \frac{individual nozzle output ( l / min ) \times 600}{driving speed ( km / h ) \times Nozzle spacing ( m )}$$

Windspeed referred to herein is the speed of wind in the area or location where pesticide and/or biostimulant is to be applied. The higher the windspeed the greater the drift, and so the drift needs to be minimized or managed by selecting a nozzle with appropriate droplet size category and appropriate pressure, whilst considering optimal biological efficiency.

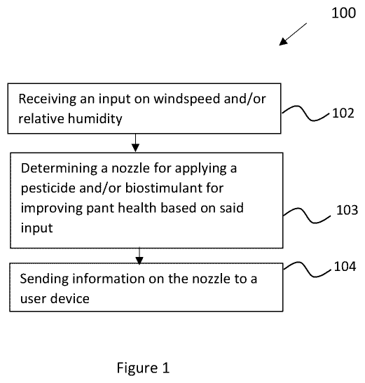

Referring now to the figures, FIG. 1 illustrates a method 100 for determining a nozzle for pesticide and/or biostimulant application. The method 100 is performed by a computing device such as a server or several servers, any other suitable computer device(s), wherein the computing device may form part of a cloud architecture. The computing device may be configured to communicate recommendations to a user device such that a user of the user device can implement the recommendations.

The method comprises the computing device receiving an input on windspeed and/or relative humidity of an area where a pesticide and/or biostimulant is to be applied 102. The computing device may receive the input on windspeed and/or relative humidity from another computing device or from a user input. When the computing device receives an input on the windspeed and/or relative humidity from another computing device, the computing device may first receive an input from a user on the location where the pesticide and/or biostimulant is to be applied, and then send a query to another computing device requesting windspeed and/or relative humidity of said location.

The method further comprises determining a nozzle for applying a pesticide and/or biostimulant for improving plant health based on said input 103, meaning that the most appropriate nozzle (or nozzles) is determined in order to optimise biological effect of the pesticide and/or biostimulant whilst minimising drift. Here, determining a nozzle should be understood as determining the type of nozzle based on its design, so the direction that the application flows out of the nozzle and/or the droplet size category.

The method further comprises sending information on the nozzle to a user device 104. This operation may comprise sending identification information of the nozzle to a user device such that the user can easily identify the nozzle. The identification information may be a product number or name.

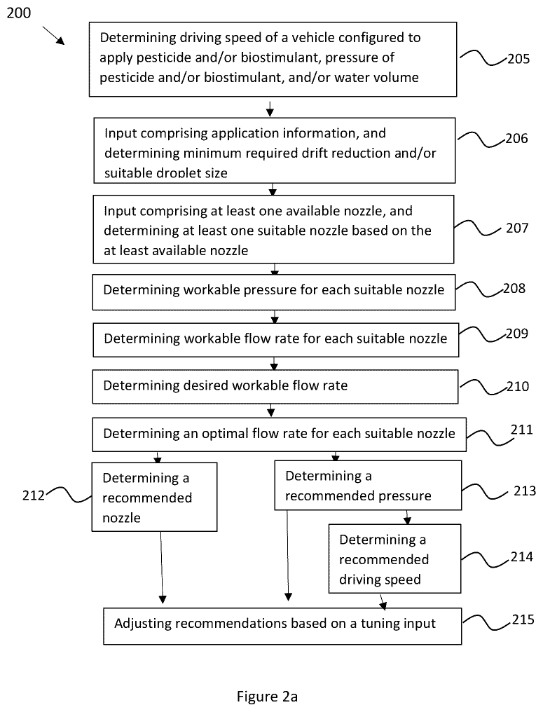

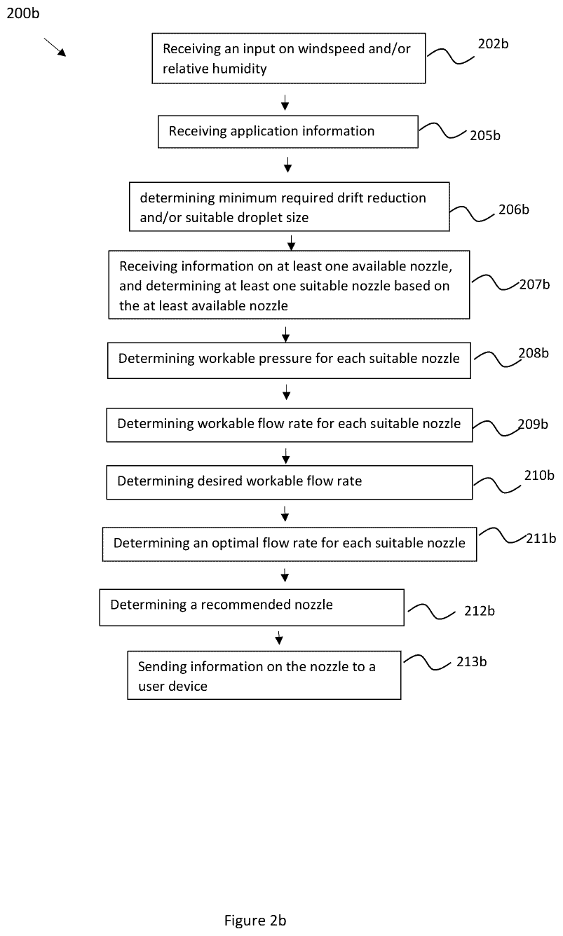

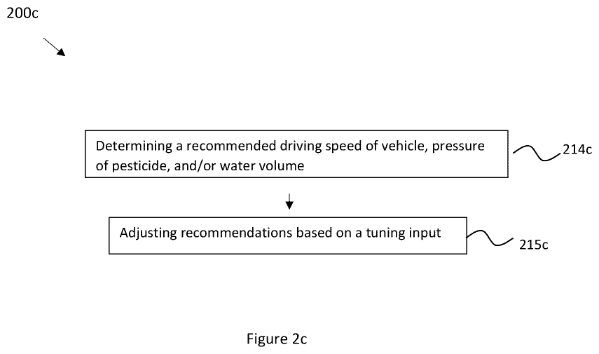

Further optional features of method 100 will now be described in relation to FIG. 2.

FIG. 2 illustrates a method 200 comprising method 100 and so a description of these operations is omitted. Method 200 further comprises optional operations of method 100. Similar to method 200, method 100 may be performed by a computing device such as a server or several servers, or any other suitable computing device.

The operations of method 200 will now be described with reference to FIG. 2.

In addition to determining a nozzle as set out in operation 103, method 200 may further comprise determining driving speed of a vehicle configured to apply pesticide and/or biostimulant, pressure of pesticide and/or biostimulant application, and/or water volume, 205.

The input in operation 102 when forming part of method 200 may further comprise an application information comprising crop type to be treated by pesticide and/or biostimulant, type of pesticide and/or biostimulant to be applied, and crop growth stage. The method 200 may further use the application information in that the method may comprise determining the minimum required drift reduction and/or suitable droplet size category whilst achieving a desired biological efficiency of the pesticide and/or biostimulant, wherein the minimum required drift reduction and/or droplet size category is based on windspeed and/or relative humidity and the application information, 206.

The input in operation 102 when forming part of method 200 may further comprise at least one available nozzle for pesticide and/or biostimulant application. The input may be available nozzles of a farmer or it may be available nozzles of a particular manufacturer or several manufacturers. The method 200 may further comprise determining at least one suitable nozzle based on the at least one available nozzle, wherein the at least one suitable nozzle is suitable for applying pesticide at or above the determined minimum required drift reduction and suitable droplet size category, 207.

The method 200 may further comprise determining at least one workable pressure for each suitable nozzle to deliver pesticide and/or biostimulant at or above the determined minimum required drift reduction and/or suitable droplet size category, wherein the at least one workable pressure for each suitable nozzle is determined based on its technical specification, 208. The technical specification of a nozzle should be understood to comprise a percentage drift reduction verses pressure characteristic. The at least one workable pressure for each suitable nozzle may also be determined based on pressure ranges set by rules and regulations of a country where the pesticide and/or biostimulant is to be applied.

The method 200 may further comprise determining at least one workable flow rate of pesticide and/or biostimulant application for each suitable nozzle based on its technical specification, 209.

The method 200 may further comprise determining a desired workable flow rate based on a speed of a vehicle configured to apply the pesticide and/or biostimulant, water volume and spacing between nozzles, 210. Thereafter, the method 200 may comprise determining an optimal flow rate for each suitable nozzle based on the workable flow rate that is closest to the desirable workable flow rate and within a maximum and minimum flow rate dictated by the driving speed of the vehicle configured to apply the pesticide and/or biostimulant, 211.

The method 200 may then comprise determining a recommended nozzle based on the optimal flow rate of the at least one suitable nozzle, 212. The operation of determining a recommended nozzle may further be based on a rating of the at least one suitable nozzle, wherein the rating is based on the at least one suitable nozzle's suitability for a specific crop, suitability for a type of pesticide and/or biostimulant, and/or the type or growth stage of the specific crop. This operation may be useful in the case where there are several suitable nozzles for an application and further ranking is required.

The method 200 may further comprise determining a recommended pressure for applying the pesticide and/or biostimulant based on the optimal flow rate, 213. The method 200 may also comprise determining a recommended driving speed of a vehicle based on water volume and the recommended pressure for each suitable nozzle, 214. In this operation, water volume may be an input from a user device wishing to receive the recommended driving speed.

Before the operations of method 100 and method 200 are carried out, there may be a preceding operation comprising determining if the application of pesticide and/or biostimulant should even be applied based on a windspeed input. This means that if the windspeed is too high, then it may be determined that it is not suitable to proceed with pesticide and/or biostimulant application and so there is no need to proceed with the operations of method 100 and/or method 200.

Once the recommendations of a nozzle, driving speed, and pressure have been determined and sent to the user device, the user device may tune the recommendations by adjusting one of them. For example, the method 200 may comprise receiving a tuning input for readjusting one of the recommendations of a nozzle, driving speed of a vehicle and pressure, and based on said tuning input, the method 200 may comprise adjusting the remaining recommendations not included in the tuning input, 215.

As can be seen methods 100 and 200 provide a user device with a recommendation of a nozzle and optionally also pressure and driving speed to be used when applying a pesticide and/or biostimulant. Methods 100 and 200 may also provide a recommendation on water volume that the user device can adjust or tune should a smaller or larger water volume be desired.

The recommendations of a nozzle, pressure, driving speed and/or water volume according to methods 100 and 200 is in consideration of optimising biological efficiency of the pesticide and/or biostimulant whilst minimising drift. This means that a farmer operating the user device will be able to apply the recommendations to improve plant health.

Another example method 200b for determining a nozzle for pesticide and/or biostimulant application will now be described with reference to FIG. 2b. The method 200b is performed by a computing device such as a server or several servers, any other suitable computer device(s), wherein the computing device may form part of a cloud architecture. The computing device may be configured to communicate recommendations to a user device such that a user of the user device can implement the recommendations.

The method comprises a computing device receiving an input on windspeed and/or relative humidity of an area where a pesticide and/or biostimulant is to be applied, 202b. The method then comprises receiving application information comprising crop type to be treated by the pesticide and/or biostimulant, type of pesticide and/or biostimulant to be applied, and crop growth stage, 205b.

As a next operation, the method comprises determining a minimum required drift reduction and/or a suitable droplet size category whilst achieving a desired biological efficiency of the pesticide and/or biostimulant, wherein the minimum required drift reduction and/or droplet size category is based on the received windspeed and/or relative humidity and the application information, 206b.

The method then comprises receiving information on at least one available nozzle for pesticide and/or biostimulant application followed by determining at least one suitable nozzle based on the at least one available nozzle 207b. The at least one suitable nozzle is suitable for applying pesticide at or above the determined minimum required drift reduction and/or at the suitable droplet size category.

Next, the method comprises determining at least one workable pressure for each suitable nozzle to deliver pesticide and/or biostimulant at or above the determined minimum required drift reduction and/or at the suitable droplet size category 208b, wherein the at least one workable pressure for each suitable nozzle is determined based on its technical specification.

The method further comprises determining at least one workable flow rate of pesticide and/or biostimulant application for each suitable nozzle based on its technical specification, 209b. Thereafter, the method comprises determining a desired workable flow rate of pesticide and/or biostimulant application based on a speed of a vehicle configured to apply the pesticide and/or biostimulant, a water volume and spacing between nozzles, 210b.

Next, the method comprises determining the optimal flow rate for each suitable nozzle based on the workable flow rate that is closest to the desired workable flow rate and within a maximum and minimum flow rate dictated by the driving speed of the vehicle configured to apply the pesticide and/or biostimulant, 211b. Thereafter, the method comprises determining a recommended nozzle based on the optimal flow rate of the at least one suitable nozzle for applying a pesticide and/or biostimulant for improving plant health based on said input, 212b, and sending information on the nozzle to a user device 213b. Here, the information on the nozzle may be understood as information identifying the type of nozzle in relation to its design, so the direction that the pesticide/biostimulant flows from the nozzle, and/or the droplet size category.

Further optional features of method 200b will now be described in relation to FIG. 2c. FIG. 2c illustrates a method 200c comprising method 200b and so a description of these operations is omitted. Similar to method 200b, method 200c may be performed by a computing device such as a server or several servers, or any other suitable computing device. It should be understood that the method 200c may more specifically be for determining a nozzle for applying a pesticide and/or biostimulant for optimising biological efficiency of the pesticide and/or biostimulant whilst minimising drift of the pesticide and/or biostimulant.

The operations of method 200c will now be described with reference to FIG. 2c.

In addition to determining a nozzle as set out in operation 212b, method 200c may further comprise determining driving speed of a vehicle configured to apply pesticide and/or biostimulant, pressure of pesticide and/or biostimulant application, and/or water volume, 214c.

The method 200c may further comprise determine the recommended nozzle based on a rating of the at least one suitable nozzle, wherein the rating is based on the at least one suitable nozzle's suitability for a specific crop, suitability for a type of pesticide and/or biostimulant, and/or the type or growth stage of the specific crop.

The method 200c may further comprise determining a recommended pressure for applying the pesticide and/or biostimulant as set out in operation 214c based on the optimal flow rate determined in operation 211b.

The method 200c may further comprise determining a recommended driving speed of the vehicle configured to apply the pesticide and/or biostimulant in operation 214c based on water volume and the recommended pressure for each suitable nozzle.

Before the operations of methods 200b and 200c are carried out, there may be a preceding operation comprising determining if the application of pesticide and/or biostimulant should even be applied based on a windspeed input. This means that if the windspeed is too high, then it may be determined that it is not suitable to proceed with pesticide and/or biostimulant application and so there is no need to proceed with the operations of method 200b and/or method 200c.

Once the recommendations of a nozzle, driving speed, and pressure have been determined and sent to the user device, the user device may tune the recommendations by adjusting one of them. For example, the method 200 may comprise receiving a tuning input for readjusting one of the recommendations of a nozzle, driving speed of a vehicle and pressure, and based on said tuning input, the method 200 may comprise adjusting the remaining recommendations not included in the tuning input, 215c.

As can be seen methods 200b and 200c provide a user device with a recommendation of a nozzle and optionally also pressure and driving speed to be used when applying a pesticide and/or biostimulant. Methods 200b and 200c may also provide a recommendation on water volume that the user device can adjust or tune should a smaller or larger water volume be desired.

The recommendations of a nozzle, pressure, driving speed and/or water volume according to methods 200b and 200c may be in consideration of optimising biological efficiency of the pesticide and/or biostimulant whilst minimising drift. This means that a farmer/grower operating the user device will be able to apply the recommendations to improve plant health.

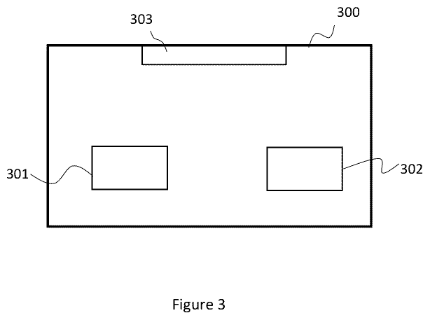

The methods of the present disclosure, as illustrated by the above examples, may be conducted by an apparatus such as a server or a user device such as a mobile phone, tablet or computer. The methods may be conducted on receipt of suitable computer readable instructions, which may be embodied within a computer program running on the apparatus. FIG. 3 illustrates an example of an apparatus 300 which may execute the methods of the present disclosure, for example on receipt of suitable instructions from a computer program. Referring to FIG. 3, the apparatus 300 comprises a processor 301 and a memory 302. The memory 302 contains instructions executable by the processor 301 such that the apparatus is operative to carry out the methods, 100, 200, 200b and 200c, as well as methods 400 and 500 described below. The apparatus 300 may further comprise a communication unit 303 for receiving input from a user or user device and for sending recommendations to a user device.

The methods of the present disclosure may be implemented in hardware, or as software modules running on one or more processors. The methods may also be carried out according to the instructions of a computer program, and the present disclosure also provides a computer program product comprising a computer readable storage medium having stored thereon a program for carrying out any of the methods described herein. A computer program embodying the disclosure may be stored on a computer-readable medium, or it could, for example, be in the form of a signal such as a downloadable data signal provided from an Internet website, or it could be in any other form.

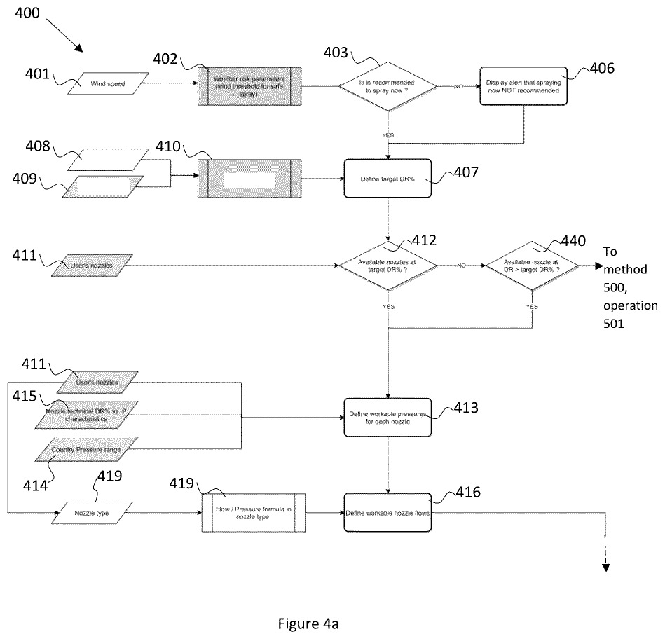

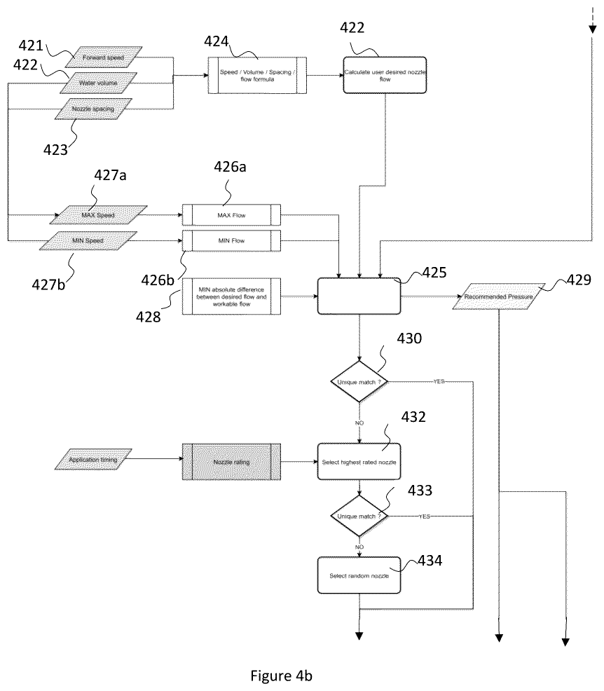

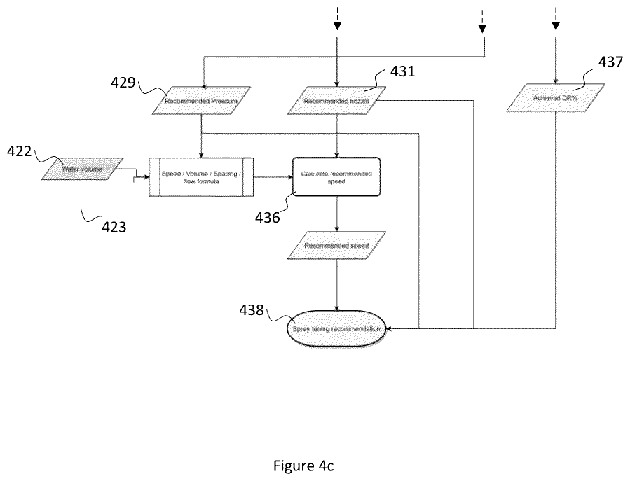

Examples of how methods 100, 200, 200b and 200c can be implemented will now be described with reference to FIGS. 4a, 4b and 4c.

FIGS. 4a, 4b and 4c illustrate a method 400 for determining a recommended nozzle, recommended pressure, and recommended driving speed for improving plant health, in particular for optimising biological efficiency of a pesticide and/or biostimulant that is to be applied to a plant whilst minimising drift. The method 400 starts in FIG. 4a, continues in FIG. 4b and ends in FIG. 4c, and it may be carried out by a computing device such as a server, several servers, any other computing device(s), wherein the computing device may form part of a cloud architecture. The computing device may be configured to communicate the recommendations to a user device such that a user of the user device can implement the recommendations.

Before method 400 is initiated, the apparatus receives an input from a user device which may be operated by a user, such as a farmer. The input may include a request to run method 400 including location information on where a pesticide and/or biostimulant application is to be carried out.

Now turning to method 400, it comprises receiving a windspeed input 401 which indicates the windspeed at a location where pesticide and/or biostimulant is to be applied to a plant such as a field of crop. The method then determines if the windspeed exceeds a threshold 402. Thereafter, the method comprises determining if it is recommended to proceed with pesticide and/or biostimulant application based on the windspeed exceeding the threshold, 403. If the windspeed exceeds the threshold, it is determined to not recommend proceeding with pesticide and/or biostimulant application 404. This decision may be sent to a user device which displays the decision to a user, such as a farmer. If it is determined that the windspeed does not exceed the threshold, then it is determined to proceed with method 400, 405.

The method 400 then determines 410 or defines a target drift reduction 407 which may be expressed in percentage. For example, 50%, 75% or 90% drift reduction. The target drift reduction may be considered to correspond to the minimum required drift reduction in methods 200, 200b, 200c. The target drift reduction 407 is determined based on a windspeed input 408 which indicates the windspeed at the location where pesticide and/or biostimulant is to be applied to a plant such as a field of crop. The target drift reduction 407 is also determined based on application information 409 comprising at least one of crop type to be treated by the pesticide and/or biostimulant, type of pesticide and/or biostimulant to be applied, and crop growth stage.

Once the target drift reduction 407 has been determined or defined, the method further comprises receiving information on the available nozzles 411. The available nozzles may be nozzles that are available to a farmer for applying pesticide and/or biostimulant. The user device initiating method 400 may provide the available nozzles, for example, through an input from a user such as a farmer. In the next operation, the available nozzles are assessed relative to the target drift reduction, 412. To explain further, nozzles in the agricultural industry are typically categorised or defined to deliver pesticide and/or biostimulant at an expected drift reduction, for example, 50%, 75% or 90%. The method comprises comparing the drift reduction associated with each nozzle with the target drift reduction so as to determine suitable nozzles for applying the pesticide and/or biostimulant.

The method then comprises determining workable pressures for each of the available nozzles 413. The workable pressures are typically pressures at which the nozzle can operate whilst achieving the target drift reduction and that comply with national rules. Thus, the workable pressures are determined based on the available nozzles 411 as described above, the technical specification 415 of each available nozzle such as the technical drift reduction verses pressure characteristics, and pressure ranges complying with rules or legislation of a country where the pesticide and/or biostimulant is to be applied 414.

In the next operation, the method 400 comprises determining or defining workable nozzle flow rates for each available nozzle, 416. A workable nozzle flow rate is the flow rate of pesticide and/or biostimulant through or from a nozzle and it may be expressed as volume per time unit, for example, litre per minute. The workable nozzle flow rates 416 for each available nozzle is determined based on the available nozzles 411 and their associated flow/pressure formula, 419.

The method further comprises determining or calculating a desired nozzle flow rate 420, wherein the desired nozzle flow rate 420 is calculated based on specific requirements or preferences 424 of a user. The specific requirements or preferences may have been sent from the user device to the apparatus performing method 400, and they may comprise driving speed of the vehicle 421, water volume 422, and nozzle spacing 423.

In the next operation, the method 400 comprises determining or defining the best or optimal nozzle flow rate 425 based on the maximum and minimum flow rates 426a, 426b which are themselves based on the maximum and minimum driving speed 427a, 427b as defined by a country's regulations. The optimal nozzle flow rate 425 is calculated 428 as the workable flow rate 416 that is closest to the desired flow rate 420 but still within the maximum and minimum flow rates.

Based on the optimal flow rate 425, the method comprises two operations, 429 and 430; one is to determine the recommended pressure 429 based on the optimal flow rate 425. The second operation is to determine if there is a match of any suitable nozzles that can achieve the optimal flow rate, 430. If there is a single match, then that nozzle is recommended in operation 431. If there are several matches, then the method proceeds to operation 432 where a nozzle is selected from the matched suitable nozzles based on a ranking of the nozzles. To explain further, the available nozzles can be ranked or rated, for example from 1 to 5 for each possible pesticide and/or biostimulant application, wherein 5 is the best rating. If there is a single match 433 of the highest ranked nozzle that can achieve the optimal flow rate, then that nozzle is recommended as set out in operation 431. If there are several matches then a random nozzle is selected 434 and then recommend in operation 431.

The method also comprises recommending a driving speed 435 of the vehicle configured to apply the pesticide and/or biostimulant. The recommended driving speed is calculated 436 based on the water volume 422 which may be inputted by the user device operated by a user such as a farmer. The water volume 422 may be the number of litres per hectare that a farmer wishes to use when applying the pesticide and/or biostimulant. The recommended driving speed is also based on the recommended pressure.

Based on the recommended pressure 429, the achieved drift reduction 437 can be determined. The achieved drift reduction can be sent to the user device where it can be displayed for viewing by a user such as a farmer. Additionally, the recommended pressure 429, nozzle 431, and driving speed 435 are also sent to the user device where they can be displayed. Upon the user viewing the recommendations, they can proceed to implement them accordingly so as to optimise biological efficiency and minimise drift during pesticide and/or biostimulant application.

The method 400 may further comprise a tuning option 438 where the user device sends a tuning input for readjusting one of the recommendations of a nozzle, driving speed of the vehicle and pressure, and based on said tuning input the server is further configured to adjust the remaining recommendations not included in the tuning input. The tuning input can be an input from a user, for example, if the user wishes to adjust the driving speed, then the nozzle and pressure recommendations will be recalculated and adjusted accordingly.

Although it is not illustrated in FIGS. 4a to 4c, the water volume may be another output or recommendation from method 400. For example, if a user device uses the tuning option 438 and readjusts any of the recommendations which affects the water volume, then a recommendation on the water volume will be made and sent to the user device.

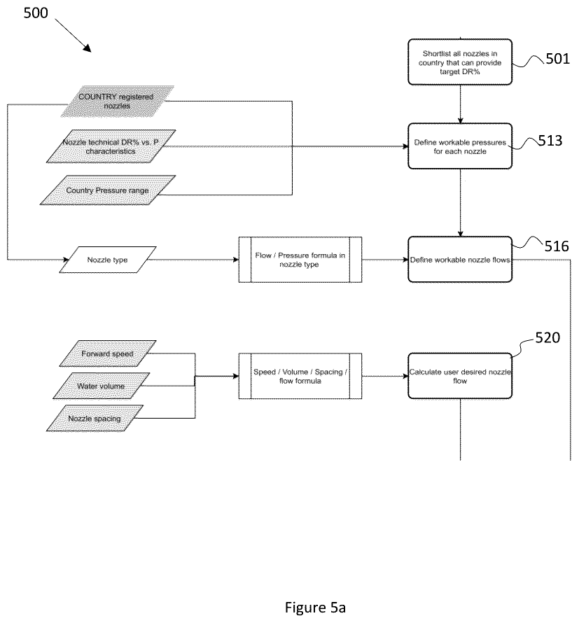

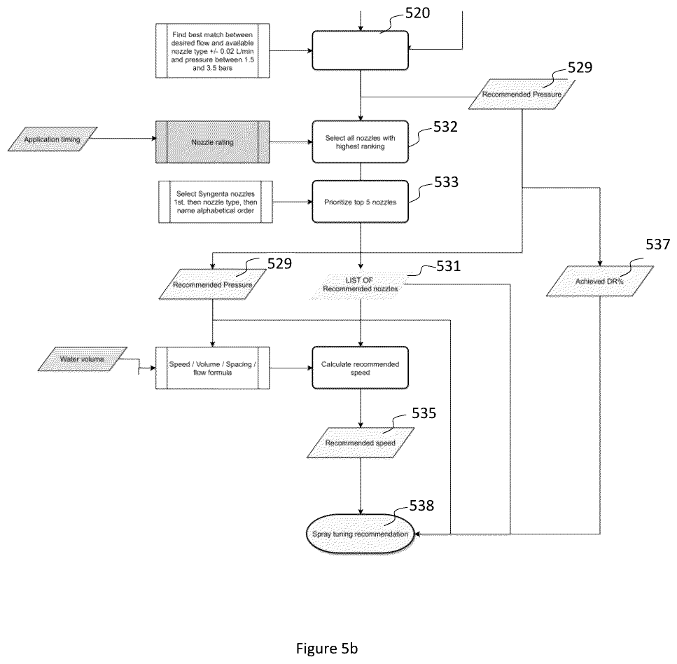

Returning now to operation 412 where it is determined if there are any available nozzles at the target drift reduction, in case it is determined that there are no available nozzle at the target drift reduction, then the method 400 further comprises determining if there are any available nozzles that provide greater drift reduction than the target drift reduction, 440. If there is, then the method proceeds with operation 413. If it is determined that there are no available nozzles, then the method proceeds with method 500 as shown in FIGS. 5a and 5b.

FIGS. 5a and 5b illustrates a method 500 for determining a nozzle for pesticide and/or biostimulant application similar to method 400, however it differs to method 400 in that it illustrates operations carried out when there are no available nozzles that can provide the minimum required drift reduction. A detailed description of operations of method 500 will be omitted where the operations have already been described in relation to method 400. Furthermore, the illustration of method 500 starts on FIG. 5a and ends on FIG. 5b.

Method 500 comprises identifying 501 all nozzles available in a country that can provide the target drift reduction determined in operation 412 of method 400. Thereafter, workable pressures for each available nozzle are determined 513, similar to operation 413. Method 500 further comprises determining or defining workable nozzle flow rates for each available nozzle 516 similar to operation 416. Thereafter, the method comprises determining or calculating a desired nozzle flow rate 520 similar to operation 420. In operation 525, an optimal nozzle flow rate is determined similar to operation 425, however the maximum and minimum flow that are country specific are not considered. Based on the optimal flow rate 525 a recommended pressure is determined 529 similar to 429.

The method further comprises selecting a nozzle or all nozzles with a highest ranking 532, similar to operation 432, and then prioritise the top 5 nozzles 533. Thereafter a list of recommended nozzles 531 is provided similar to operation 431. A recommended driving speed 535 is also determined similar to operation 435. Method 500 may also comprise an achieved drift reduction 537 similar to operation 437 and a tuning option 538.

Methods 400 and 500 can alternatively be based on relative humidity as an input rather than windspeed. For example, the methods 400 and 500 may determine 410 or define a target droplet size category 407 rather than drift reduction, wherein the droplet size category is based on relative humidity at the location where pesticide and/or biostimulant is to be applied to a plant such as a field of crop. The target droplet size category 407 may in this example also be determined based on the application information 409.

Once the target droplet size category 407 has been determined or defined, the methods 400 and 500 may further comprise receiving information on the available nozzles 411 as described above in connection with FIGS. 4a, 4b, 4c, 5a and 5b. In the next operation, the available nozzles may be assessed relative to the target droplet size category, 412. To explain further, nozzles in the agricultural industry are typically categorised or defined to deliver pesticide and/or biostimulant at a target droplet size category. The methods 400 and 500 may comprise comparing the droplet size category associated with each nozzle with the target droplet size category so as to determine suitable nozzles for applying the pesticide and/or biostimulant.

Methods 400 and 500 may then continue with operation 413 and 513, respectively, as described above.

It should also be understood that methods 400 and 500 may also comprise windspeed in combination with relative humidity as an input and determining target drift reduction and target droplet size category as set out above.

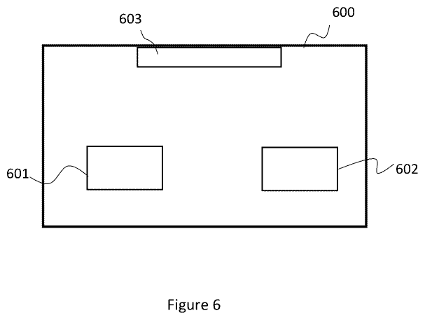

A computing device for determining a nozzle for pesticide and/or biostimulant application will now be described with reference to FIG. 6.

FIG. 6 illustrates a block diagram of a computing device 600 which may comprise a processor 601 and a memory 603. The computing device 600 may also comprise a communication interface 603 for communicating with a user device and/or other computing devices including servers. The computing device may comprise any combination of the features described above in connection with the methods, apparatus, computer programs, and/or computer program products.

In one example, the computing device 600 is configured to receive an input on windspeed and/or relative humidity of an area where a pesticide and/or biostimulant is to be applied, receive application information comprising crop type to be treated by the pesticide and/or biostimulant, type of pesticide and/or biostimulant to be applied, and crop growth stage. The computing device 600 is further configured to determine a minimum required drift reduction and/or a suitable droplet size category whilst achieving a desired biological efficiency of the pesticide and/or biostimulant, wherein the minimum required drift reduction and/or droplet size category is based on windspeed and/or relative humidity and the application information (206b). The computing device 600 is further configured to receive information on at least one available nozzle for pesticide and/or biostimulant application, determine at least one suitable nozzle based on the at least one available nozzle, wherein the at least one suitable nozzle is suitable for applying pesticide at or above the determined minimum required drift reduction and/or at the suitable droplet size category; determine at least one workable pressure for each suitable nozzle to deliver pesticide and/or biostimulant at or above the determined minimum required drift reduction and/or at the suitable droplet size category, wherein the at least one workable pressure for each suitable nozzle is determined based on its technical specification; and determine at least one workable flow rate of pesticide and/or biostimulant application for each suitable nozzle based on its technical specification. The computing device is further configured to determine a desired workable flow rate of pesticide and/or biostimulant application based on a driving speed of a vehicle configured to apply the pesticide and/or biostimulant, a water volume and spacing between nozzles; determine the optimal flow rate for each suitable nozzle based on the workable flow rate that is closest to the desired workable flow rate and within a maximum and minimum flow rate dictated by the driving speed of the vehicle configured to apply the pesticide and/or biostimulant; and determine a recommended nozzle based on the optimal flow rate of the at least one suitable nozzle for applying a pesticide and/or biostimulant for improving plant health based on said input, and send information on the nozzle to a user device.

The computing device may be configured to determine a nozzle for applying a pesticide and/or biostimulant for improving plant health comprises the computing device being configured to determine a nozzle for applying a pesticide and/or biostimulant for optimising biological efficiency of the pesticide and/or biostimulant whilst minimising drift of the pesticide and/or biostimulant.

The computing device may be further configured to determine a driving speed of a vehicle configured to apply pesticide and/or biostimulant, pressure of pesticide and/or biostimulant application, and/or water volume.

The computing device may be further configured to determine the recommended nozzle based on a rating of the at least one suitable nozzle, wherein the rating is based on the at least one suitable nozzle's suitability for a specific crop, suitability for a type of pesticide and/or biostimulant, and/or the type or growth stage of the specific crop.

The computing device may be configured to determine a recommended pressure for applying the pesticide and/or biostimulant based on the optimal flow rate.

The computing device is configured to determine a recommended driving speed of the vehicle configured to apply the pesticide and/or biostimulant based on water volume and the recommended pressure for each suitable nozzle.

The computing device me be configured to determine if the pesticide and/or biostimulant should be applied at all based on windspeed.

The computing device may be configured to receive a tuning input for readjusting one of the recommendations of a nozzle, driving speed of the vehicle and pressure, and based on said tuning input the computing device is further configured to adjust the remaining recommendations not included in the tuning input. In another example, the computing device 600 is configured to receive an input on windspeed and/or relative humidity of an area where a pesticide and/or biostimulant is to be applied, determine a nozzle for applying a pesticide and/or biostimulant for improving plant health based on said input, and send information on the nozzle to a user device.

Optional features of this other example of the computing device of FIG. 600 will now be described.

The computing device may be configured to determine a nozzle for applying a pesticide and/or biostimulant for improving plant health comprises the computing device being configured to determine a nozzle for applying a pesticide and/or biostimulant for optimising biological efficiency of the pesticide and/or biostimulant whilst minimising drift of the pesticide and/or biostimulant.

The computing device may be further configured to determine a driving speed of a vehicle configured to apply pesticide and/or biostimulant, pressure of pesticide and/or biostimulant application, and/or water volume.

The input further may comprise an application information comprising: crop type to be treated by the pesticide and/or biostimulant, type of pesticide and/or biostimulant to be applied, and crop growth stage, and the computing device may further be configured to determine a minimum required drift reduction and/or a suitable droplet size category whilst achieving a desired biological efficiency of the pesticide and/or biostimulant, wherein the minimum required drift reduction and/or droplet size category is based on windspeed and/or relative humidity and the application information.

The input may further comprise at least one available nozzle for pesticide and/or biostimulant application, and the computing device is configured to determine at least one suitable nozzle based on the at least one available nozzle, wherein the at least one suitable nozzle is suitable for applying pesticide at or above the determined minimum required drift reduction and/or at the suitable droplet size category.

The computing device may further be configured to determine at least one workable pressure for each suitable nozzle to deliver pesticide and/or biostimulant at or above the determined minimum required drift reduction and/or at the suitable droplet size category, wherein the at least one workable pressure for each suitable nozzle is determined based on its technical specification.

The computing device may further be configured to determine at least one workable flow rate of pesticide and/or biostimulant application for each suitable nozzle based on its technical specification.

The computing device may further be configured to determine a desired workable flow rate of pesticide and/or biostimulant application based on a speed of a vehicle configured to apply the pesticide and/or biostimulant, a water volume and spacing between nozzles.

The computing device may further be configured to determine the optimal flow rate for each suitable nozzle based on the workable flow rate that is closest to the desired workable flow rate and within a maximum and minimum flow rate dictated by the driving speed of the vehicle configured to apply the pesticide and/or biostimulant.

The computing device may be configured to determine a recommended nozzle based on the optimal flow rate of the at least one suitable nozzle.

The computing device may further be configured to determine the recommended nozzle based on a rating of the at least one suitable nozzle, wherein the rating is based on the at least one suitable nozzle's suitability for a specific crop, suitability for a type of pesticide and/or biostimulant, and/or the type or growth stage of the specific crop.

The computing device may be configured to determine a recommended pressure for applying the pesticide and/or biostimulant based on the optimal flow rate.

The computing device may be configured to determine a recommended driving speed of the vehicle configured to apply the pesticide and/or biostimulant based on water volume and the recommended pressure for each suitable nozzle.

The computing device may be further configured to determine if the pesticide and/or biostimulant should be applied at all based on windspeed.

The computing device may be configured to receive a tuning input for readjusting one of the recommendations of a nozzle, driving speed of the vehicle and pressure, and based on said tuning input the computing device is further configured to adjust the remaining recommendations not included in the tuning input.

It should be noted that the above-mentioned examples illustrate rather than limit the disclosure, and that those skilled in the art will be able to design many alternative examples without departing from the scope of the appended claims. The word “comprising” does not exclude the presence of elements or steps other than those listed in a claim, “a” or “an” does not exclude a plurality. Any reference signs in the claims shall not be construed so as to limit their scope.

1. A computing device for determining a nozzle for pesticide and/or biostimulant application, wherein the computing device is configured to;
receive an input on windspeed and/or relative humidity of an area where a pesticide and/or biostimulant is to be applied;
receive application information comprising crop type to be treated by the pesticide and/or biostimulant, type of pesticide and/or biostimulant to be applied, and crop growth stage, the computing device is further configured to;
determine a minimum required drift reduction and/or a suitable droplet size category whilst achieving a desired biological efficiency of the pesticide and/or biostimulant, wherein the minimum required drift reduction and/or droplet size category is based on windspeed and/or relative humidity and the application information;
receive information on at least one available nozzle for pesticide and/or biostimulant application, and the computing device is further configured to;
determine at least one suitable nozzle based on the at least one available nozzle, wherein the at least one suitable nozzle is suitable for applying pesticide at or above the determined minimum required drift reduction and/or at the suitable droplet size category;
determine at least one workable pressure for each suitable nozzle to deliver pesticide and/or biostimulant at or above the determined minimum required drift reduction and/or at the suitable droplet size category, wherein the at least one workable pressure for each suitable nozzle is determined based on its technical specification;
determine at least one workable flow rate of pesticide and/or biostimulant application for each suitable nozzle based on its technical specification;
determine a desired workable flow rate of pesticide and/or biostimulant application based on a driving speed of a vehicle configured to apply the pesticide and/or biostimulant, a water volume and spacing between nozzles;
determine the optimal flow rate for each suitable nozzle based on the workable flow rate that is closest to the desired workable flow rate and within a maximum and minimum flow rate dictated by the driving speed of the vehicle configured to apply the pesticide and/or biostimulant;
determine a recommended nozzle based on the optimal flow rate of the at least one suitable nozzle for applying a pesticide and/or biostimulant for improving plant health based on said input, and
send information on the nozzle to a user device.

2. The computing device according to claim 1, wherein the computing device being configured to determine a nozzle for applying a pesticide and/or biostimulant for improving plant health comprises the computing device being configured to determine a nozzle for applying a pesticide and/or biostimulant for optimising biological efficiency of the pesticide and/or biostimulant whilst minimising drift of the pesticide and/or biostimulant.

3. The computing device according to claim 1, wherein the computing device is further configured to determine a driving speed of a vehicle configured to apply pesticide and/or biostimulant, pressure of pesticide and/or biostimulant application, and/or water volume.

4. The computing device according to claim 1, when the computing device is further configured to determine the recommended nozzle based on a rating of the at least one suitable nozzle, wherein the rating is based on the at least one suitable nozzle's suitability for a specific crop, suitability for a type of pesticide and/or biostimulant, and/or the type or growth stage of the specific crop.

5. The computing device according to claim 1, wherein the computing device is configured to determine a recommended pressure for applying the pesticide and/or biostimulant based on the optimal flow rate.

6. The computing device according to claim 4, wherein the computing device is configured to determine a recommended driving speed of the vehicle configured to apply the pesticide and/or biostimulant based on water volume and the recommended pressure for each suitable nozzle.

7. The computing device according to claim 1, wherein the computing device is further configured to determine if the pesticide and/or biostimulant should be applied at all based on windspeed.

8. The computing device according to claim 4, wherein the computing device is configured to receive a tuning input for readjusting one of the recommendations of a nozzle, driving speed of the vehicle and pressure, and based on said tuning input the computing device is further configured to adjust the remaining recommendations not included in the tuning input.
